(19) United States
(12) Patent Application Publication
(10) Pub. No.: US 2025/0211431 A1
(43) Pub. Date: Jun. 26, 2025

(54) SECRET SHARING COMPUTATION SYSTEM, RELAY APPARATUS, AND METHODS AND PROGRAMS THEREOF

(71) Applicant: NEC Corporation, Minato-ku, Tokyo (JP)

(72) Inventors: Masahiro Nara, Tokyo (JP); Toshiyuki Isshiki, Tokyo (JP); Kengo Mori, Tokyo (JP); Haruna Fukuda, Tokyo (JP); Satoru Fujii, Tokyo (JP); Takuya Takaseki, Tokyo (JP)

(73) Assignee: NEC Corporation, Minato-ku, Tokyo (JP)

(21) Appl. No.: 18/847,763

(22) PCT Filed: Mar. 23, 2022
(86) PCT No.: PCT/JP2022/013524

§ 371 Date: Sep. 17, 2024

(51) Int. Cl. H04L 9/08

(52) U.S. Cl. CPC H04L 9/0861; H04L 9/0825; H04L 9/085

(57) ABSTRACT

A multi-party computation method includes: using a relay apparatus that relays communication between a user apparatus and MPC operation apparatuses in a multi-party computation system including at least one user apparatus and two or more MPC operation apparatuses; having the relay apparatus receive a first encryption key generated by each MPC operation apparatus and further transmit the first encryption key to the user apparatus; having the relay apparatus receive secret shares generated by the user apparatus and encrypted thereby using the first encryption key and a second encryption key generated by the user apparatus and transmit the encrypted secret shares and the second encryption key to each MPC operation apparatus; and having the relay apparatus further receive shares, encrypted using the user apparatus's second encryption key, of the results of operations performed by the MPC operation apparatuses and transmit the shares to the user apparatus.

This application is a National Stage Entry of PCT/JP2022/013524 filed on Mar. 23, 2022, the contents of all of which are incorporated herein by reference, in their entirety.

### FIELD

The present invention relates to a secure computation technology, in particular to a secret sharing computation technology, and more particularly to a so-called secret sharing multi-party computation (MPC) technology.

### BACKGROUND

In a basic scheme of secret sharing multi-party computation (MPC), each user (client) generates secret shares of confidential information for a plurality of MPC participants' MPC servers, transmitting shares directly to each MPC server, and when receiving the results of the MPC processing, each user also receives the shares of the results sent directly from each MPC server.

In this process, it is known that the communication between each user and the MPC servers is encrypted. Merely encrypting the communication of information (data), however, does not provide sufficient resistance against an attack by a malicious third party; therefore, various countermeasures have been proposed.

In this context, it is also necessary to consider convenience of use for a plurality of users.

### PATENT LITERATURE 1

Japanese Patent Kokai Publication No. JP-P2013-26954A

### Non-Patent Literature

### Non-Patent Literature 1

T. Rabin, M. Ben-Or, “Verifiable Secret Sharing and Multiparty Protocols with Honest Majority,” STOC1989, pp. 73-85

### SUMMARY

The following analysis is provided by the present invention. Further, the content of each document cited above is incorporated herein in its entirety by reference thereto. That is to say, the content of each document cited above is utilized herein as necessary. In the conventional secret sharing multi-party computation (MPC), each user (client) generates secret-shares of confidential information for a plurality of MPC servers, transmitting shares directly to each MPC server, and when receiving the results of the MPC processing, each user also receives the shares of the results sent directly from each MPC server.

However, in the conventional secret sharing multi-party computation (MPC), considering the fact that it is used by unspecified users, there is a problem that the implementation of computation in a secure confidential environment against malicious users is not necessarily guaranteed. In particular, the scheme is insufficient in terms of concealing the identities of multi-party computation participants from users.

For instance, Patent Literature 1 discloses an encrypted data search system capable of returning search results to search requests from a plurality of users having different public and private keys and reducing data leakage. In this system, a service providing apparatus generates a service public key and a service private key for encrypting data and accepts a user private key generated by a user apparatus requesting a data search and the service private key to generate a proxy key for each user apparatus, the user apparatus generates a user query for requesting a data search for searchable encrypted data, a proxy apparatus accepts the user query and the proxy key to generate a search query for requesting a search of the searchable encrypted data, and the user apparatus generates the user query using the user private key (refer to Abstract, FIGS. 1 to 7 and 15). In other words, the presence (location) information of the service providing apparatus or the proxy apparatus is a prerequisite for users requesting a search in the communication (search results being returned to search requests) between the plurality of user apparatuses and the service providing apparatus or the proxy apparatus. Therefore, this technology merely demonstrates a specific usage of user private keys and service private keys, and it is not useful for solving the problem described above.

It is an object of the present disclosure to provide a secret sharing computation technology, particularly a secret sharing computation system, relay apparatus, and methods and programs thereof, that can contribute to implementing secret sharing multi-party computation in a more advanced confidential environment, more specifically implementing secret sharing multi-party computation in a confidentiality-preserving environment in which the participants in the multi-party computation are not known to a user.

According to a first aspect of the present disclosure, there is provided a multi-party computation system. The multi-party computation system includes at least one user apparatus, a plurality of MPC operation apparatuses, and a relay apparatus that relays communication between the user apparatus and each MPC operation apparatus, wherein the user apparatus is configured to include a secret sharing part that divides information to generate secret shares of the information, an encryption part that encrypts the secret shares, a reception part that receives a key for encrypting shares and encrypted shares of MPC operation results, and a transmission part that transmits encrypted shares and a key for encryption to the relay apparatus, the relay apparatus is configured to include a reception part that receives encrypted shares, a key for encryption, and encrypted shares of MPC operation results and a transmission part that transmits encrypted shares, a key for encryption, and encrypted shares of MPC operation results, and the plurality of MPC operation apparatuses are configured to include a reception part that receives encrypted shares and a key for encryption from the relay apparatus, a key generation part that generates a key, a decryption part that decrypts encrypted shares, and an operation part that performs an operation using decrypted shares. Further, the relay apparatus is configured to receive respective first encryption keys generated by the plurality of MPC operation apparatuses and further transmit the respective first encryption keys to the user apparatus and is configured to receive secret shares generated by the user apparatus and encrypted thereby using the respective first encryption keys and a second encryption key generated by the user apparatus and transmit the encrypted secret shares and the second encryption key to the plurality of MPC operation apparatuses, and the relay apparatus is further configured to receive shares, encrypted using the user apparatus's second encryption key, of the results of operations performed by the plurality of MPC operation apparatuses and transmit the shares to the user apparatus.

According to a second aspect of the present disclosure, there is provided the following relay apparatus (or relay system). The relay apparatus relays communication between a user apparatus and a plurality of MPC operation apparatuses in a multi-party computation system including at least one user apparatus and a plurality of MPC operation apparatuses, wherein the relay apparatus includes a reception part that receives encrypted shares and a key for encryption and a transmission part that transmits encrypted shares and a key for encryption, one of each for the user apparatus and the MPC operation apparatuses, the relay apparatus is configured to receive respective first encryption keys generated by the plurality of MPC operation apparatuses and further transmit the respective first encryption keys to the user apparatus and is configured to receive secret shares generated by the user apparatus and encrypted thereby using the respective first encryption keys and a second encryption key generated by the user apparatus and transmit the encrypted secret shares and the second encryption key to the plurality of MPC operation apparatuses, and the relay apparatus is further configured to receive shares, encrypted using the user apparatus's second encryption key, of the results of operations performed by the plurality of MPC operation apparatuses and transmit the shares to the user apparatus.

According to a third aspect of the present disclosure, there is provided the following multi-party computation method. The multi-party computation method includes the following: using a relay system that relays communication between a user apparatus and a plurality of MPC operation apparatuses in a multi-party computation system including at least one user apparatus and a plurality of MPC operation apparatuses; having the relay system receive respective first encryption keys generated by the plurality of MPC operation apparatuses and further transmit the respective first encryption keys to the user apparatus; having the relay system receive secret shares generated by the user apparatus and encrypted thereby using the respective first encryption keys and a second encryption key generated by the user apparatus and transmit the encrypted secret shares and the second encryption key to the plurality of MPC operation apparatuses; and having the relay system further receive shares, encrypted using the user apparatus's second encryption key, of the results of operations performed by the plurality of MPC operation apparatuses and transmit the shares to the user apparatus.

According to a fourth aspect of the present disclosure, there is provided the following multi-party computation program. The multi-party computation program causes a computer to execute the following processes: using a relay system that relays communication between a user apparatus and a plurality of MPC operation apparatuses in a multi-party computation system including at least one user apparatus and a plurality of MPC operation apparatuses; having the relay system receive respective first encryption keys generated by the plurality of MPC operation apparatuses and further transmit the first encryption keys to the user apparatus; having the relay system receive secret shares generated by the user apparatus and encrypted thereby using the respective first encryption keys and a second encryption key generated by the user apparatus and transmit the encrypted secret shares and the second encryption key to each MPC operation apparatus; and having the relay system further receive shares, encrypted using the user apparatus's second encryption key, of the results of operations performed by the plurality of MPC operation apparatuses and transmit the shares to the user apparatus. (This enables the decryption of the encrypted MPC operation result shares received by the user apparatus.)

This computation programs can be stored in a non-transitory storage medium, and a hard disk, a semiconductor recording medium, a magnetic recording medium, an optical recording medium, and other well-known recording media may be used as the storage medium. The computer itself can be configured as hardware, can be any commercially available one, and comprises a processor and a storage device (such as a memory) that stores program instructions for implementing the processor. Furthermore, it is possible to construct the multi-party computation system, including the user apparatus, the relay system, and the MPC operation apparatuses, as a virtual system on a physical infrastructure, which includes a computer, based on the predetermined physical infrastructure, either in part or as a whole system.

According to each aspect of the present disclosure or each example embodiment thereof, there is provided a secret sharing computation technology, particularly a secret sharing computation system, relay apparatus (or relay system), and methods and programs thereof, that can contribute to implementing secret sharing multi-party computation in a more advanced confidential environment, more specifically implementing secret sharing multi-party computation in a confidentiality-preserving environment in which the participants in the multi-party computation are not known to a user.

### BRIEF DESCRIPTION OF DRAWINGS

FIG. 1 schematically illustrates an example of a conceptual structure according to the principles of secret sharing multi-party computation (MPC) (in the case of three parties).

FIG. 2 schematically illustrates an example of a conceptual structure of a system having a plurality of user apparatuses (clients) UXj (j=A, B, C) and three MPC servers (participants) MPCXi (i=1, 2, 3).

FIG. 3 schematically illustrates an example in which a relay apparatus (or a relay system such as a proxy server) is provided between a client and MPC servers.

FIG. 4 shows a conceptual diagram of an example of secret key generation by a client and a plurality of MPC servers.

FIG. 5 schematically illustrates a process of generating and encrypting input shares of confidential information by the client using secret sharing and a process of transmitting the shares via the proxy server and generating each input share by decrypting it in the plurality of MPC servers (key uplink processes).

FIG. 6 schematically illustrates a process of encrypting shares of results in the plurality of MPC servers, a process of transmitting the shares to the client via the proxy server, and a process of generating and reconstructing the shares of the results by having the client receive and decrypt the encrypted data (key downlink processes).

FIG. 7 schematically illustrates a process of generating keys (ski, pki) in the plurality of MPC servers and a process of transmitting the public key pki to the proxy server.

FIG. 8 schematically illustrates key parts of the uplink process in a case where biometric features are used as the confidential information shown in FIG. 5.

FIG. 9 schematically illustrates a variation of key downlink parts corresponding to the uplink in the case of using biometric features shown in FIG. 8.

FIG. 10 schematically illustrates an example of a basic configuration of a multi-party computation (MPC) system relating to an example embodiment.

FIG. 11 schematically illustrates an example of a relay apparatus used in the multi-party computation (MPC) system relating to an example embodiment.

FIG. 12 schematically illustrates an example of a user apparatus used in the multi-party computation (MPC) system relating to an example embodiment.

FIG. 13 schematically illustrates an example of a participant apparatus used the multi-party computation (MPC) system relating to an example embodiment.

FIG. 14 schematically illustrates an example of the flow of a multi-party computation (MPC) method relating to an example embodiment.

FIG. 15 schematically illustrates an example of a hardware configuration relating to an example embodiment.

### EXAMPLE EMBODIMENTS

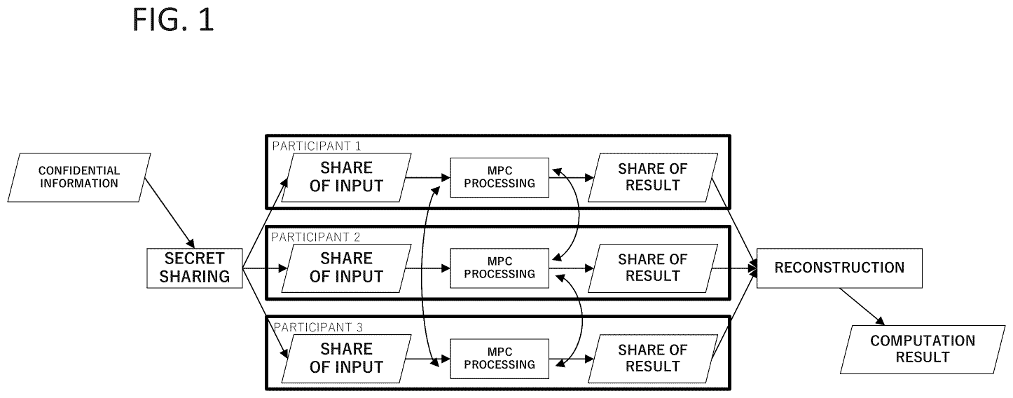

First, the following provides an overview of secret sharing multi-party computation (MPC). FIG. 1 schematically illustrates an example of a conceptual structure according to the principles of secret sharing multi-party computation (MPC) (in the case of three parties).

#Confidential information is distributed to three participants using secret sharing.

#1 The secretly shared fragments of information distributed to and held by three participants are called shares (shares of the input).

#2 Each share does not reveal the confidential information on its own, but when two shares are combined, the confidential information can be reconstructed.

#3 The computation is executed on each fragment of the distributed information of the confidential information and each distributed computation result is obtained as a distributed fragment of each result (a share of each computation result).

#4 By collecting the shares of each computation result, the reconstructed computation result can be obtained.

Here, “secret sharing,” also known as secure distribution, refers to a process of generating shares (fragments of information) from the original data while maintaining confidentiality (the same applies to each of the aspect described above).

Further, a “share” refers to a fragment of information generated by distributing (splitting) the original data into a predetermined number of pieces of information (the same applies to each of the aspect described above). “Multi-party computation” (MPC) refers to a computation scheme in which a plurality of computation participants (parties) perform computer calculations (operations) on a share allocated to each of them, and the individual results are collected to derive the final computation result (the same applies to each of the aspect described above). An “MPC operation” refers to a computational process performed by each participant in multi-party computation on his or her allocated share.

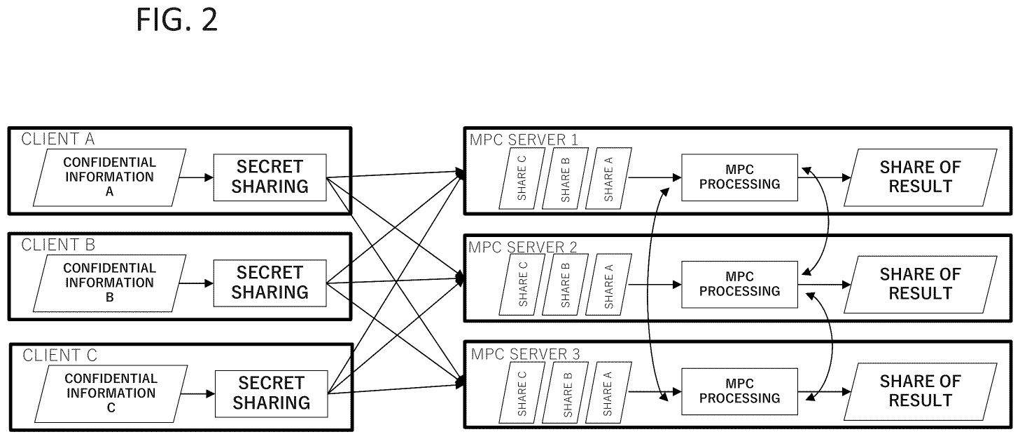

FIG. 2 schematically illustrates an example of a conceptual structure of a system having a plurality of user apparatuses (clients) UXj (j=A, B, C) and three MPC servers (participant apparatuses) MPCXi (i=1, 2, 3).

#1 Each client (A, B, C) divides confidential information (A, B, C) to generate secret shares of the information and transmits the respective shares (A, B, C) to each MPC server (1, 2, 3).

#2 Each MPC server performs MPC processing based on the received shares (input shares) and obtains shares of each result.

#In this case, each client generates secret shares of the confidential information for each MPC server and directly transmits the secret shares to each MPC server.

When receiving the shares of the MPC processing results, each client also directly receives them from each MPC server.

The scheme described above has the following problem:
If the clients directly access each MPC server, the ID, the address, and the location of each MPC server will be revealed to each client.
Since untrusted users may also access the servers, it is desirable to keep the locations of the MPC servers hidden from the clients, but this is not currently achieved.

Therefore, in an example embodiment of the present disclosure, the following measure is proposed to solve the problem above. That is to say, by incorporating a particular relay apparatus (or a relay system such as a proxy server) between the clients and the MPC servers, the locations of the MPC servers can be hidden from the user apparatuses (clients). Further, the communication between the relay apparatus, the clients, and the MPC servers will be based on an encrypted communication method to ensure the confidentiality of the communication.

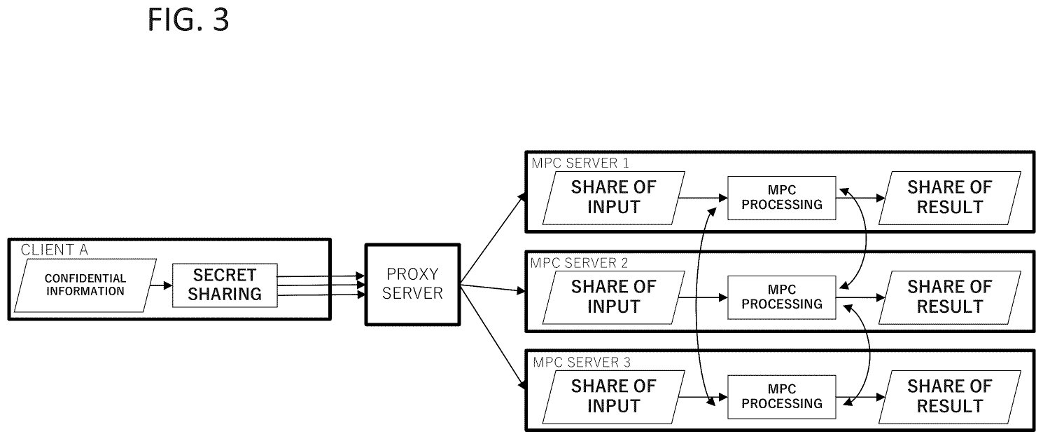

FIG. 3 schematically illustrates an example of a typical configuration thereof (an example of a three-party MPC involving three MPC servers (1, 2, and 3) for a client A). In the example of FIG. 3, a proxy server acts as a proxy for all three MPC servers; however, when there are many MPC servers, a plurality of proxy servers may be provided as necessary. Further, in FIG. 3, one relay apparatus (the proxy server) is provided for a single client A; however, it goes without saying that a single relay apparatus can also handle a plurality of clients. FIG. 3 shows a single client A for the sake of conceptual clarity. In addition, the curved bidirectional arrows between the MPC servers indicate coordination (communication) among the MPC servers and illustrate a necessity for communication between participants (the MPC servers) when a product is calculated during MPC operations.

The following describes an outline of an example embodiment of the present disclosure. It should be noted that the drawing reference signs in the outline are given to each element for convenience an as example to facilitate understanding, and the description in the outline is not intended to impose any limitation. Further, connection lines between blocks in each drawing can be both bidirectional and unidirectional. A unidirectional arrow schematically shows the main flow of a signal (data) and does not exclude bidirectionality. In addition, in circuit diagrams, block diagrams, internal configuration diagrams, and connection diagrams shown in the disclosure of the present application, the input and output ends of each connection line have input and output ports, respectively, although not shown explicitly. The same applies to input/output interfaces. Moreover, it should be understood that the numbers of the individual apparatuses, the individual parts, the individual elements, and the individual signals described are not limited to the numbers in the examples described and any number (including intermediate values or ranges) may be employed as needed. Further, it should be noted that Japanese nouns have the same form for both singular and plural.

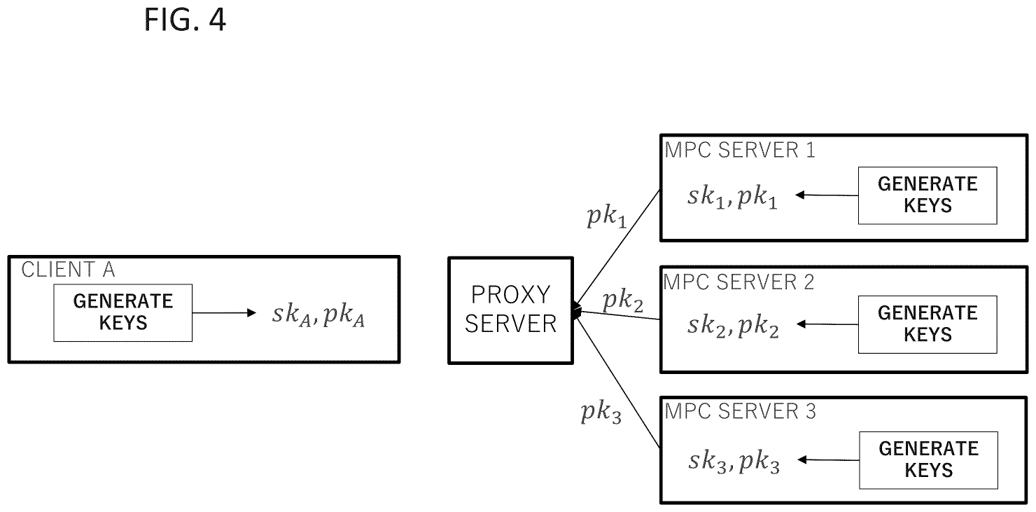

FIG. 4 illustrates an example of a setup configuration of the system. The left and right sides represent the upstream and downstream sides, respectively.

#1 A client A and each MPC server MPCXi (i=1, 2, 3) generate a public key

pk_{A}

and a secret key

SK_{A}

of public key cryptography for the client A, and each MPC server MPCXi (i=1, 2, 3) generates a public key pki (i=1, 2, 3) and a secret key ski (i=1, 2, 3). (This public key pki corresponds to the respective first encryption key in the first aspect.)

#2 Each MPC server transmits the generated public key to the proxy server.

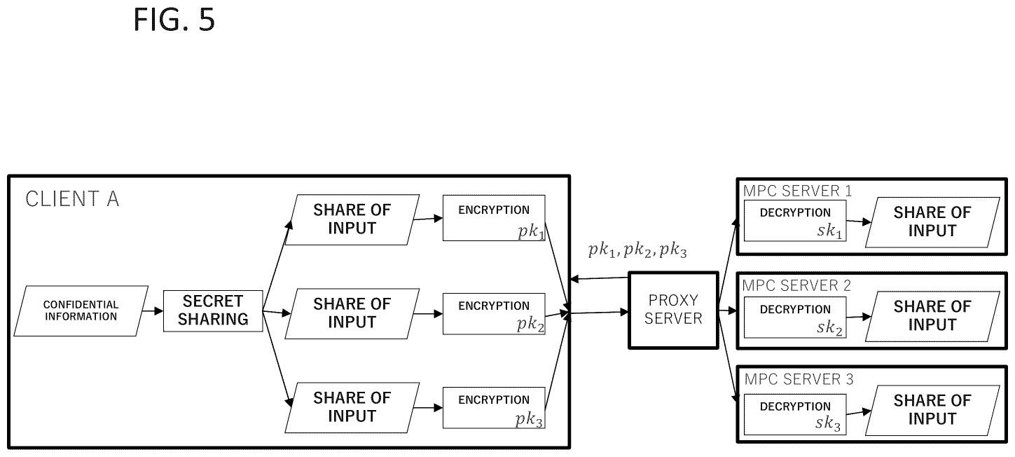

FIG. 5 schematically illustrates a process of transmitting shares of confidential information from the client (a stage in which the client transmits shares).

1. The client requests the public key pki of each MPC server from the proxy server PX.

2. The proxy server PX transmits the public key pki of each MPC server to the client.

3. The client divides confidential information to generate secret shares of the information.

4. The client encrypts the shares using the public key pki of each MPC server.

5. The client transmits the shares encrypted using the public key pki of each MPC server and the client's public key

pk_{A}

(corresponding to the user apparatus's second encryption key in the first aspect) to the proxy server PX.

6. The proxy server PX transmits the encrypted shares and the client's public key

pk_{A}

to each MPC server.

7. Each MPC server (1, 2, 3) decrypts the encrypted share using its respective secret key ski to obtain each share (1, 2, 3) of the input.

Here, the client's public key

pk_{A}

is transmitted because it is used when the MPC operation results are returned.

According to the configuration described above, during the transmission from the client to the MPC servers via the proxy server, a high level of confidentiality is ensured while the locations of the MPC servers are hidden from the client.

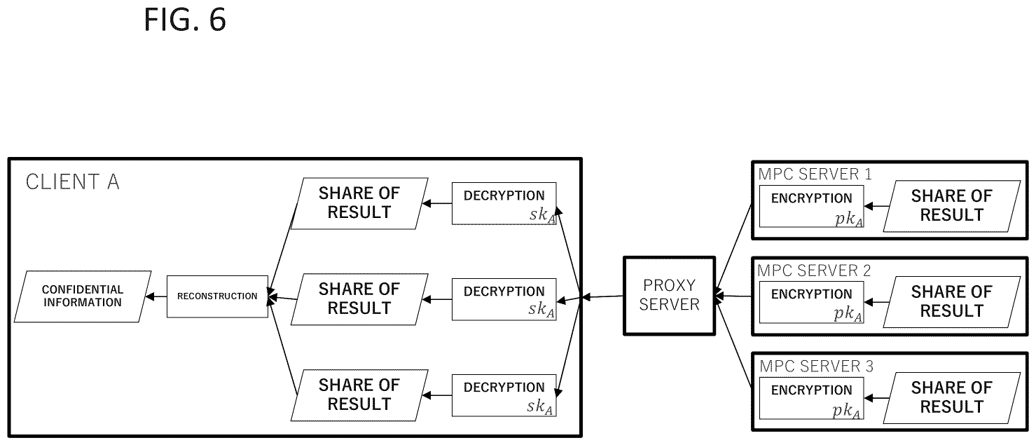

FIG. 6 schematically illustrates key parts of a process of transmitting (shares of) the computation results from the MPC servers to the client (a stage in which the MPC servers transmit the computation results; downlink).

#1 Each MPC server encrypts the share of the computation result using the public key

pk_{A}

generated by the client A (and received from the proxy server).

#2 Each MPC server transmits the encrypted share of the computation result to the proxy server PX.

#3 The proxy server PX transmits the encrypted shares of the computation results to the client A.

#4 The client A decrypts the encrypted shares of the computation results using his or her own secret key SK_{A}.

#5 The client reconstructs the shares of the computation results to obtain the result of the computation on the confidential information.

According to the configuration described above, when the plurality of MPC servers transmit the computation results to the client via the proxy server, a high level of confidentiality is ensured while the locations of the MPC servers are hidden from the client.

The encrypted communication above uses public key cryptography, as an example, i.e., using different keys (the public and secret keys) for encrypting and decrypting the exchanged data, and data encrypted with the public key can only be decrypted with the secret key (and vice versa). The encrypted communication method used, however, is not limited thereto and can be chosen on the basis of the desired security level. Common key cryptography or the so-called hybrid cryptosystem may also be used. It is desirable to encrypt the transmission and the reception of confidential information (or the shares of the information) at a minimum, and encrypting the transmission and the reception of encryption keys, when necessary, contributes to ensuring a higher level of security. In a hybrid cryptosystem, the transmission of a key is also encrypted. In this case, a common key can be encrypted using public key cryptography, allowing for secure key exchange. Additionally, key exchange may be performed so that the sender and the receiver share a common key, and for instance, both parties may use the other party's public key and his or her own secret key to generate the same common key. After the common key has been exchanged, this common key may be used to encrypt and decrypt exchanged data. This hybrid cryptosystem is utilized in HTTPS communication, and some or all thereof can be used in the present disclosure with predetermined adjustments as necessary. Other encryption methods can also be selected as long as the confidentiality of communication can be ensured and the locations of the sender and the receiver can be concealed.

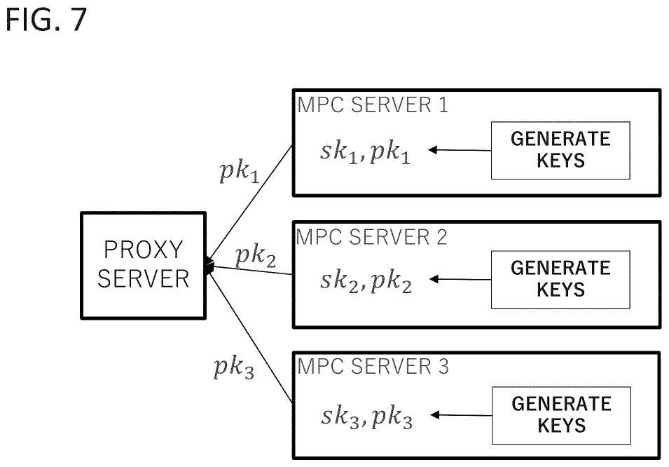

FIG. 7 schematically illustrates an example of a downstream setup as a concrete example. This downstream setup can be applied to biometric authentication.

#1 Each MPC server (1, 2, 3) MPCXi (i=1, 2, 3) generates a public key pki (i=1, 2, 3) and a secret key ski (i=1, 2, 3) of public key cryptography.

#2 Each MPC server transmits the generated public key pki to the proxy server PX.

As an example of the premise, the upstream setup is as illustrated in FIG. 4. Under these setup conditions, the following illustrates a case where biometric information is used as confidential information.

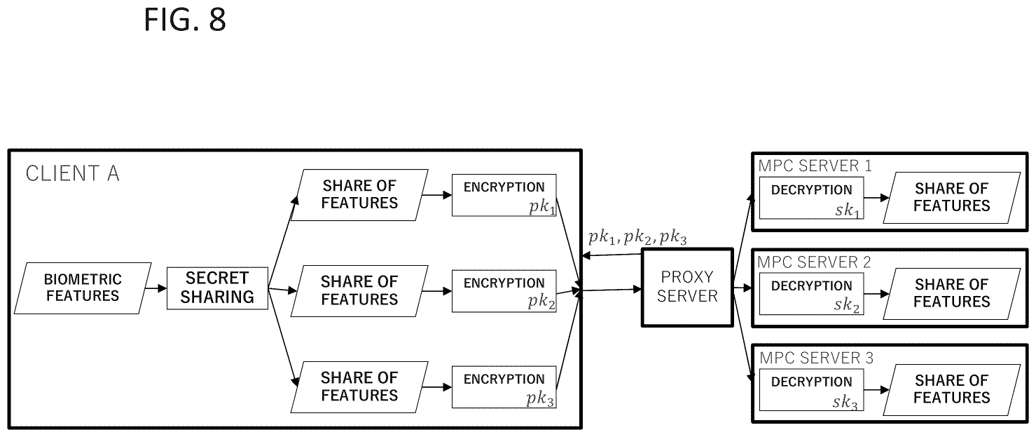

FIG. 8 schematically illustrates a process of transmitting shares of biometric features from the client to each MPC server under the setup conditions in the concrete example above (key parts of a stage in which the client transmits shares to each MPC server MPCXi (i=1, 2, 3) (uplink)).

1. The client requests the public key pki (i=1, 2, 3) of each MPC server MPCXi from the proxy server PX.

2. The proxy server PX transmits the public key pki (i=1, 2, 3) of each MPC server to the client.

3. The client A splits the biometric features to generate secret shares of the features.

4. The client A encrypts each share of the features using the public key pki (i=1, 2, 3) of each MPC server.

5. The client A transmits the encrypted shares of the features to the proxy server PX.

6. The proxy server PX transmits the encrypted shares of the features to each MPC server.

7. Each MPC server MPCXi decrypts the encrypted share of the features using its own secret key ski.

8. Each MPC server MPCXi performs MPC operations on the decrypted share of the features to obtain a share of the result as the computation outcome. This completes the uplink communication, and if necessary, the shares of the results are stored in a storage device.

Next comes a stage of transmitting the share of each result from each MPC server to the client (downlink). Each MPC server encrypts the feature share of each result stored in the storage device using the client's public key

pk_{A}

and transmits it to the proxy server. The proxy server transmits the encrypted share of each result to the client, and the client, upon receiving it, decrypts the share using his or her own secret key

SK_{A}

to obtain the share of each result. The client collects the shares of the results to reconstruct and obtain the biometric features as confidential information. These processes are basically the same as the key downlink processes shown in FIG. 6.

The following is an overview of a multi-party computation system according to a first example embodiment of the present disclosure.

The multi-party computation system includes: at least one user apparatus; a plurality of (two or more) MPC operation apparatuses; and a relay apparatus that relays communication between the client apparatus and the plurality of MPC operation apparatuses, wherein the user apparatus is configured to include a secret sharing part that divides information to generate secret shares of the information, an encryption part that encrypts the secret shares, a reception part that receives a key for encrypting shares and encrypted shares of MPC operation results, and a transmission part that transmits encrypted shares and a key for encryption to the relay apparatus, the relay apparatus is configured to include a reception part that receives encrypted shares, a key for encryption, and encrypted shares of MPC operation results and a transmission part that transmits encrypted shares, a key for encryption, and encrypted shares of MPC operation results, and the plurality of MPC operation apparatuses are configured to include a reception part that receives encrypted shares and a key for encryption from the relay apparatus, a key generation part that generates a key, a decryption part that decrypts encrypted shares, and an operation part that performs an operation using decrypted shares. Further, the relay apparatus is configured to receive respective first encryption keys generated by the plurality of MPC operation apparatuses and further transmit the first encryption keys to the user apparatus and is configured to receive secret shares generated by the user apparatus and encrypted thereby using the respective first encryption keys and a second encryption key generated by the user apparatus and transmit the encrypted secret shares and the second encryption key to the plurality of MPC operation apparatuses, and the relay apparatus is further configured receive shares, encrypted using the user apparatus's second encryption key, of the results of operations performed by the plurality of MPC operation apparatuses and transmit the shares to the user apparatus.

As a concrete example of the first example embodiment described above, the following example can be considered, i.e., a case where each of the respective first encryption keys is a first public key, and the second encryption key is a second public key. Typically, the first and the second public keys are different from each other. In this case, as stated above, encrypted communication can employ public key cryptography.

In this case, specifically, the following configuration can be adopted as an example. That is to say, the multi-party computation system includes: at least one client apparatus UXj (j is an integer greater than or equal to one); a plurality of (two or more) MPC operation apparatuses MPCXi (i is an integer greater than or equal to one and two); and a relay apparatus that relays communication between the client apparatus and the plurality of MPC operation apparatuses, wherein the client apparatus is configured to include a secret sharing part that divides information to generate secret shares of the information, an encryption part that encrypts the secret shares, a reception part that receives a key for encrypting shares and encrypted shares of MPC operation results, and a transmission part that transmits encrypted shares and a key for encryption to the relay apparatus, the relay apparatus is configured to include a reception part that receives encrypted shares, a key for encryption, and encrypted shares of MPC operation results and a transmission part that transmits encrypted shares, a key for encryption, and encrypted shares of MPC operation results, and the plurality of MPC operation apparatuses are configured to include a reception part that receives encrypted shares and a key for encryption from the relay apparatus, a key generation part that generates a key, a decryption part that decrypts encrypted shares, and an operation part that performs an operation using decrypted shares. Further, the relay apparatus is configured to receive public keys pki (i=1, 2, . . . ) generated by the plurality of MPC operation apparatuses and further transmit the public keys pki to the client apparatus and is configured to receive secret shares generated by the client apparatus and encrypted thereby using the public keys pki and a public key pkj generated by the client apparatus and transmit the encrypted secret shares and the public key to the plurality of MPC operation apparatuses, and the relay apparatus is further configured to receive shares, encrypted using the client apparatus's public key pkj, of the results of operations performed by the plurality of MPC operation apparatuses and transmit the shares to the client apparatus.

### (Concrete Mode 1)

Further, the first example embodiment can be expanded into the following concrete modes.

In the multi-party computation system of the first example embodiment, the user apparatus is configured to divide information to generate secret shares of the information and encrypt the secret shares using the (respective) first encryption keys received from a relay system and is configured to receive shares, encrypted using the user apparatus's second encryption key, of the results of operations performed by the plurality of MPC operation apparatuses, and the MPC operation apparatuses are configured to receive shares encrypted using the (respective) first encryption keys transmitted by the relay apparatus, decrypt the encrypted shares, and perform an operation using the decrypted shares.

### (Concrete Mode 2)

The relay apparatus is configured to transmit the (respective) first encryption keys generated by the plurality of MPC operation apparatuses to the user apparatus in response to a request from the user apparatus.

### (Concrete Mode 3)

The plurality of MPC operation apparatuses are configured to further decrypt shares, which are encrypted using the (respective) first encryption keys transmitted by the relay apparatus, using further (respective) third encryption keys.

### (Concrete Mode 4)

The user apparatus is configured to further decrypt shares of MPC operation results, which are encrypted using the second encryption key, using a further fourth encryption keys.

### (Concrete Mode 5)

When the relay apparatus receives encrypted shares of the results of operations performed by the plurality of MPC operation apparatuses and transmits the shares to a user apparatus without decrypting them, the client apparatus is configured to decrypt the encrypted shares of the MPC operation results.

### (Concrete Mode 6)

Each of the respective first encryption keys is a first public key, and the second encryption key is a second public key.

### (Concrete Mode 7)

The following is an overview of a relay apparatus as a second example embodiment of the present disclosure. The relay apparatus relays communication between a user apparatus and a plurality of MPC operation apparatuses in a multi-party computation system including at least one user apparatus and a plurality of (two or more) MPC operation apparatuses, wherein the relay apparatus includes a reception part that receives encrypted shares and a key for encryption and a transmission part that transmits encrypted shares and a key for encryption, one of each for the user apparatus and the MPC operation apparatuses, the relay apparatus is configured to receive (respective) first encryption keys generated by the plurality of MPC operation apparatuses and further transmit the (respective) first encryption keys to the user apparatus and is configured to receive secret shares generated by the user apparatus and encrypted thereby using the (respective) first encryption keys and a second encryption key generated by the user apparatus and transmit the encrypted secret shares and the second encryption key to the plurality of MPC operation apparatuses, and the relay apparatus is further configured to receive shares, encrypted using the user apparatus's second encryption key, of the results of operations performed by the plurality of MPC operation apparatuses and transmit the shares to the user apparatus.

As a concrete example of the second example embodiment described above, the following example can be considered. The relay apparatus relays communication between a client apparatus and a plurality of MPC operation apparatuses in a multi-party computation system including at least one client apparatus UXj (j is an integer greater than or equal to one) and a plurality of (two or more) MPC operation apparatuses MPCXi (i is an integer greater than or equal to one and two), wherein the relay apparatus includes a reception part that receives encrypted shares and a key for encryption and a transmission part that transmits encrypted shares and a key for encryption, one of each for the client and the MPC operation apparatuses, the relay apparatus is configured to receive public keys pki (i=1, 2, . . . ) generated by the plurality of MPC operation apparatuses (corresponding to the respective first encryption keys), further transmit the public keys to the client apparatus, receive secret shares generated by the client apparatus and encrypted thereby using the public keys pki and a (respective) public key pkj generated by the client apparatus, and transmit the encrypted secret shares and the public key pkj to the plurality of MPC operation apparatuses, and the relay apparatus is further configured to receive shares, encrypted using the client's public key pkj, of the results of operations performed by the plurality of MPC operation apparatuses and transmit the shares to the client.

The following is an overview of a multi-party computation method as a third example embodiment of the present disclosure. The multi-party computation method includes the following steps: using a relay system that relays communication between a user apparatus and a plurality of MPC operation apparatuses in a multi-party computation system including at least one user apparatus and a plurality of (two or more) MPC operation apparatuses; having the relay system receive (respective) first public keys generated by the plurality of MPC operation apparatuses and further transmit the (respective) first public keys to the user apparatus; having the relay system receive secret shares generated by the user apparatus and encrypted thereby using the first public keys and a second public key generated by the user apparatus and transmit the encrypted secret shares and the second public key to each MPC operation apparatus; and having the relay system further receive shares, encrypted using the user apparatus's second public key, of the results of operations performed by the plurality of MPC operation apparatuses and transmit the shares to the user apparatus.

As a concrete example of the third example embodiment described above, the following example can be considered. The multi-party computation method includes the following steps: using a relay system that relays communication between a client apparatus and a plurality of MPC operation apparatuses in a multi-party computation system including at least one client apparatus UXj (j is an integer greater than or equal to one) and a plurality of (two or more) MPC operation apparatuses MPCXi (i is an integer greater than or equal to one and two); having the relay system receive (respective) public keys pki (i=1, 2, . . . ) generated by the plurality of MPC operation apparatuses and further transmit the (respective) public keys pki to the client apparatus; having the relay system receive secret shares generated by the client apparatus and encrypted thereby using the (respective) public keys pki and a (respective) public key pkj generated by the client apparatus and transmit the encrypted secret shares and the public key pkj to each MPC operation apparatus; and having the relay system further receive shares, encrypted using the client apparatus's (respective) public key pkj, of the results of operations performed by the plurality of MPC operation apparatuses and transmit the shares to the client apparatus.

The following describes a multi-party computation program as a fourth example embodiment of the present disclosure. The multi-party computation program causes a computer to execute the following processes: using a relay system that relays communication between a user apparatus and a plurality of MPC operation apparatuses in a multi-party computation system including at least one user apparatus and a plurality of (two or more) MPC operation apparatuses; having the relay system receive (respective) first public keys generated by the plurality of MPC operation apparatuses and further transmit the (respective) first public keys to the user apparatus; having the relay system receive secret shares generated by the user apparatus and encrypted thereby using the (respective) first public keys and a second public key generated by the user apparatus and transmit the encrypted secret shares and the second public key to the plurality of MPC operation apparatuses; and having the relay system further receive shares, encrypted using the user apparatus's second public key, of the results of operations performed by the plurality of MPC operation apparatuses and transmit the shares to the user apparatus.

As a concrete example of the fourth example embodiment described above, the following example can be considered. The multi-party computation program causes a computer to execute the following processes: using a relay system that relays communication between a client apparatus and a plurality of MPC operation apparatuses in a multi-party computation system including at least one client apparatus UXj (j is an integer greater than or equal to one) and a plurality of (two or more) MPC operation apparatuses MPCXi (i is an integer greater than or equal to one and two); having the relay system receive (respective) public keys pki (i=1, 2, . . . ) generated by the plurality of MPC operation apparatuses and further transmit the (respective) public keys pki to the client apparatus; having the relay system receive secret shares generated by the client apparatus and encrypted thereby using the (respective) public keys pki and a (respective) public key pkj generated by the client apparatus and transmit the encrypted secret shares and the public key pkj to the plurality of MPC operation apparatuses; and having the relay system further receive shares, encrypted using the client apparatus's (respective) public key pkj, of the results of operations performed by the plurality of MPC operation apparatuses and transmit the shares to the client apparatus.

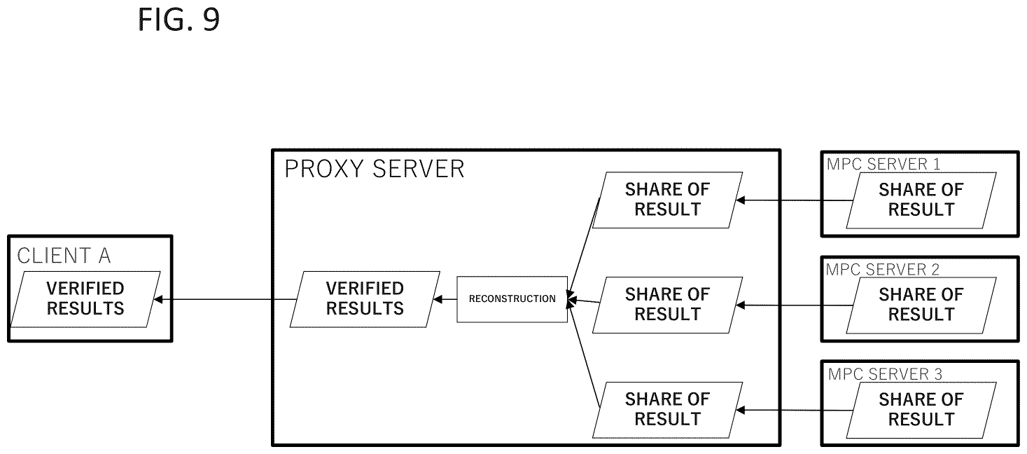

FIG. 9 schematically illustrates a variation of the (downlink) process of transmitting shares of computation results from the plurality of MPC servers to the client in the concrete example described above.

#1 Each MPC server MPCXi encrypts the share of the computation result and transmits the encrypted share to the proxy server PX.

#2 The proxy server PX decrypts and reconstructs (i.e., verifies) the share of each computation result to obtain verified results.

#3 The proxy server PX encrypts the verified results and transmits them to the client A.

The overall flow including the above steps is as follows:

First, the uplink process is the same as that described above shown in FIG. 5.

1. The client A requests the public key of each MPC server from the proxy server PX.

2. The proxy server transmits the public key pki (i=1, 2, . . . ) of each MPC server to the client.

3. The client A splits biometric features to generate secret shares of the input.

4. The client A encrypts the input shares using the public key pki (i=1, 2, . . . ) of each MPC server.

5. The client A transmits the encrypted input shares to the proxy server.

6. The proxy server PX transmits the encrypted input shares to each MPC server.

7. Each MPC server decrypts the encrypted input share using its own secret key ski to obtain the share of the features and stores it in the storage device as needed. Next comes the downlink communication described above.

In this variation, MPC processing can also be performed under a predetermined confidential environment without revealing the location of each MPC server to the client by utilizing a proxy server as a relay apparatus.

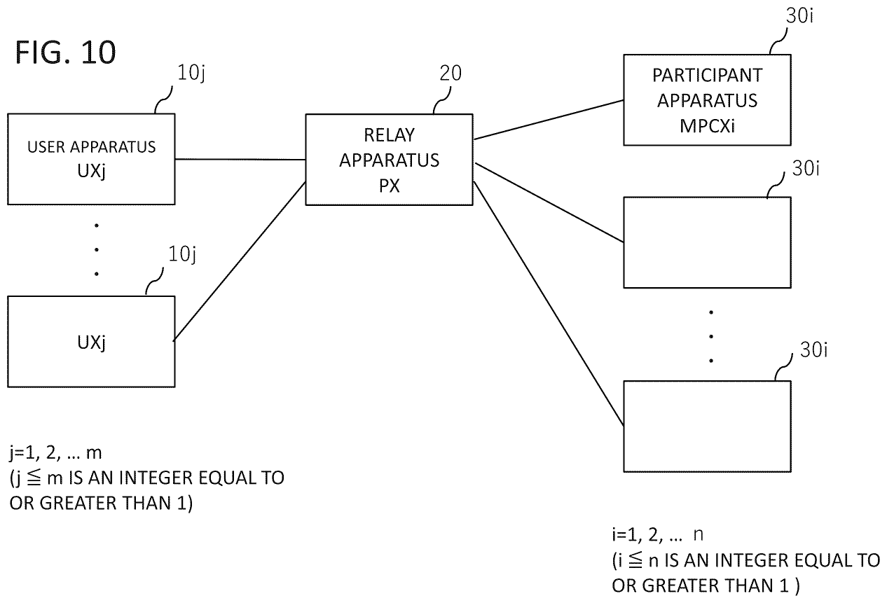

FIG. 10 schematically illustrates an example of a basic configuration of a secret sharing multi-party computation (MPC) system relating to an example embodiment. The configuration example of FIG. 10 includes at least one user apparatus 10j, a relay apparatus 20, and two or more MPC participant apparatuses 30i. As the user apparatus, there are the client apparatuses UXj (j=1, 2, . . . , m, i.e., j is an integer greater than or equal to one), each of which is communicably connected to the relay apparatus PX. The plurality of participant apparatuses MPCXi (i=1, 2, . . . , n, i.e., i is an integer greater than or equal to one and two) are communicably connected to the relay apparatus PX. The connection form is not limited and may be wired, wireless, or a combination of both, and communication is possible via the public communication network, the Internet. In other words, the plurality of user apparatuses are communicably connected to the plurality of MPC participant apparatuses MPCXi via the relay apparatus PX. Each user apparatus, however, can only directly communicate with the relay apparatus. Each connection line is bidirectional and can transmit a plurality of signals or packets.

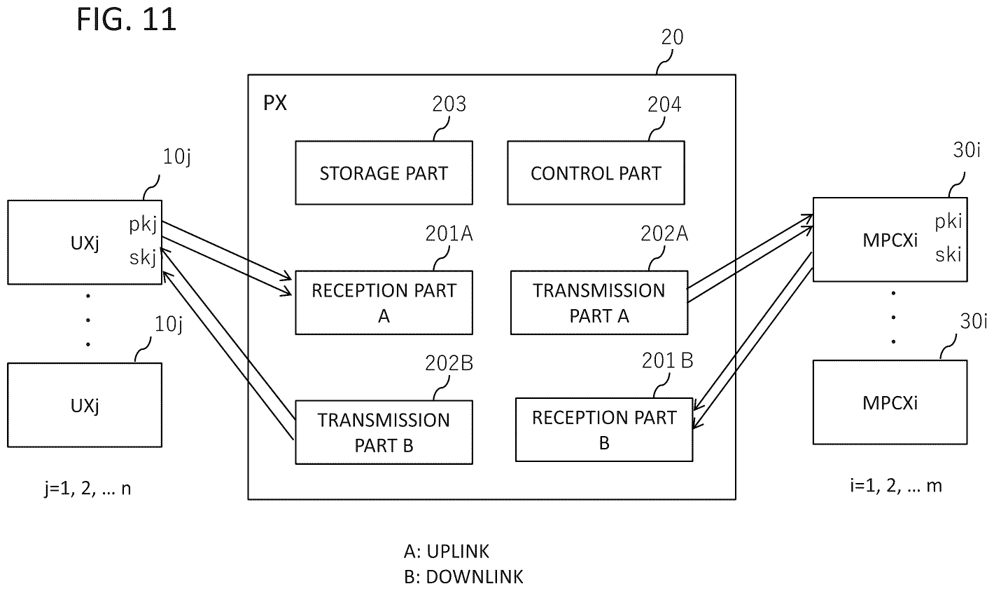

FIG. 11 schematically illustrates an example of a relay apparatus used in the multi-party computation (MPC) system relating to an example embodiment. The relay apparatus 20 shown in the center includes a storage part 203 and a control part 204, and comprises a reception part A (201A) and a transmission part A (202A) for uplink communication from the perspective of a user apparatus, and a reception part B (201B) and a transmission part B (202B) for downlink communication. Symbols A and B represent uplink and downlink, respectively. In other words, the relay apparatus includes a reception part that receives encrypted shares and a key for encryption and a transmission part that transmits encrypted shares and a key for encryption, one of each for the client and the MPC operation apparatuses. The operation of the relay apparatus is controlled by instructions given via the control part 204 according to a control program stored in the storage part 203. For instance, settings, such as denying access from a user apparatus without access privileges, can be configured in advance. An example of a measure for this purpose is to employ user authentication. Although not shown in the drawing, an input/output device, a display device, and the like may be provided for the relay apparatus.

In FIG. 11, arrows are used to indicate the direction of signals supplied/transmitted to/from the relay apparatus. In downlink communication, the relay apparatus receives respective public keys pki (i=1, 2, . . . ) generated by the plurality of MPC operation apparatuses MPCXi with the reception part B (201B) and further transmits the public keys pki from the transmission part B (202B) to the user apparatus UXj. This downlink transmission of the public keys pki is performed in response to a request from the user apparatus UXj, but the source (origin) information of the public keys pki is not transmitted. Next, in uplink communication, the reception part A (201A) receives secret shares i generated by the user apparatus and encrypted thereby using the public keys pki and a public key pkj generated by the user apparatus, and the transmission part A (202A) transmits the encrypted secret shares and the public key pkj to each MPC operation apparatus MPCXi.

During each process of reception and transmission, the communication data are temporarily stored in the storage part 203 as needed and are transmitted to a predetermined destination usually stored and set in advance (or newly stored by new access) according to the instructions from the control part 204. Note that the data (including the keys) forwarded to the user apparatus do not include the source (origin) information thereof. Through the relay apparatus structured and configured as described, (encrypted) distributed share information and predetermined encryption key signals (for decrypting the shares) for secret sharing multi-party computation (MPC) can be transmitted by the user apparatus under a predetermined confidential environment without revealing the location of each MPC participant to the user apparatus, and the corresponding MPC operation results can be received. Further, the encryption scheme used in the communication is not limited to the public key cryptography described in the example, and as stated above, other encryption schemes may be employed. In particular, encrypting the transmission of the encryption keys contributes to ensuring a higher level of security.

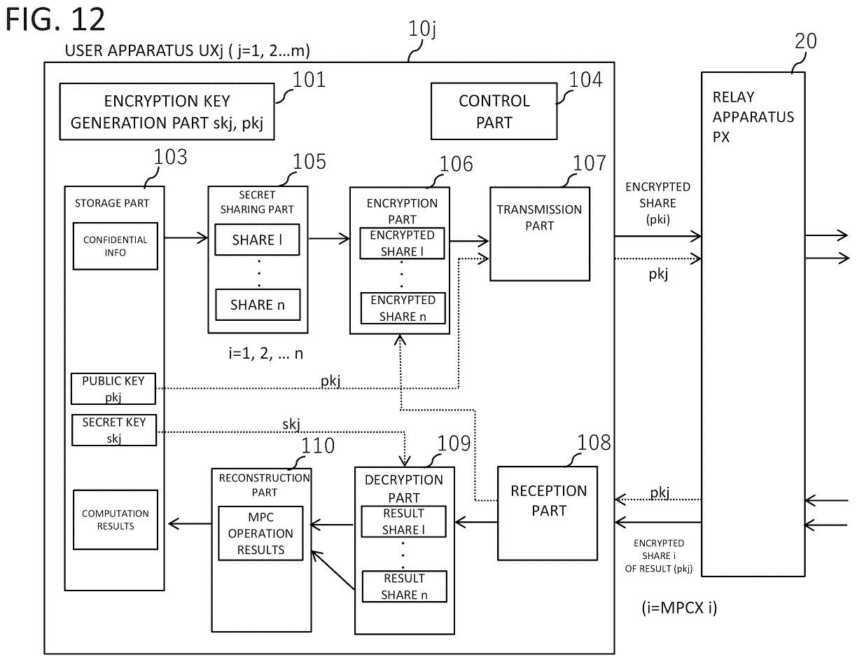

FIG. 12 schematically illustrates an example of a user apparatus used in the multi-party computation (MPC) system relating to an example embodiment. The user apparatus UXj (10j) (j=1, 2, . . . , m, i.e., j is an integer greater than or equal to one) comprises an encryption key generation part 101, a control part 104, a storage part 103, a secret sharing part 105, an encryption part 106, a transmission part 107, a reception part 108, a decryption part 109, and a reconstruction part 110. The encryption key generation part 101 is activated by a session start (trigger) signal supplied through an input/output interface (not shown the drawing) according to a program stored in advance, generates and sets up an encryption key, generates and sets up the secret key skj and the public key pkj, stores them in the storage part, and transmits the public key pkj to the relay apparatus PX via the transmission part 107 according to instructions from the control part 104. The secret key skj is later supplied from the storage part 103 to the decryption part 109 and is used to decrypt shares of MPC operation results. The secret sharing part 105 divides confidential information stored in the storage part 103 into secret sharing information fragments (i.e., the shares i) according to the control instruction program stored in the control part 104. Here, i denotes a numerical value corresponding to i (i=1, 2, . . . , n) of the MPC operation apparatus MPCXi, which is the MPC participant apparatus. In other words, the confidential information is divided into a number of shares that corresponds to the number of participant apparatuses participating in the MPC session. The encryption part 106 encrypts each share using the public key pki (stored in the storage part as needed) supplied by the relay apparatus PX via the reception part 108 to generate an encrypted share i (pki). The transmission part 107 then transmits these encrypted shares i to the relay apparatus PX. The above constitutes a starting part (the incipient part) of the upstream flow.

Next, the following describes the lowest part of the downstream flow from the relay apparatus PX. Encrypted shares (pkj) of MPC operation results, i.e., shares (pkj) of MPC operation results encrypted using the public key pkj of each user apparatus UXj, are transmitted from the relay apparatus PX to the reception part of the user apparatus UXj without revealing the sources (origins) of the encrypted shares, and supplied to and decrypted by the decryption part 109. At this time, the user apparatus's own secret key skj supplied by the storage part 103 is used.

The decrypted shares i of the MPC operation results (i=1, 2, . . . , n) are sent to the reconstruction part 110, where the shares are aggregated and reconstructed to obtain the MPC operation results, which are then stored in the storage part 103.

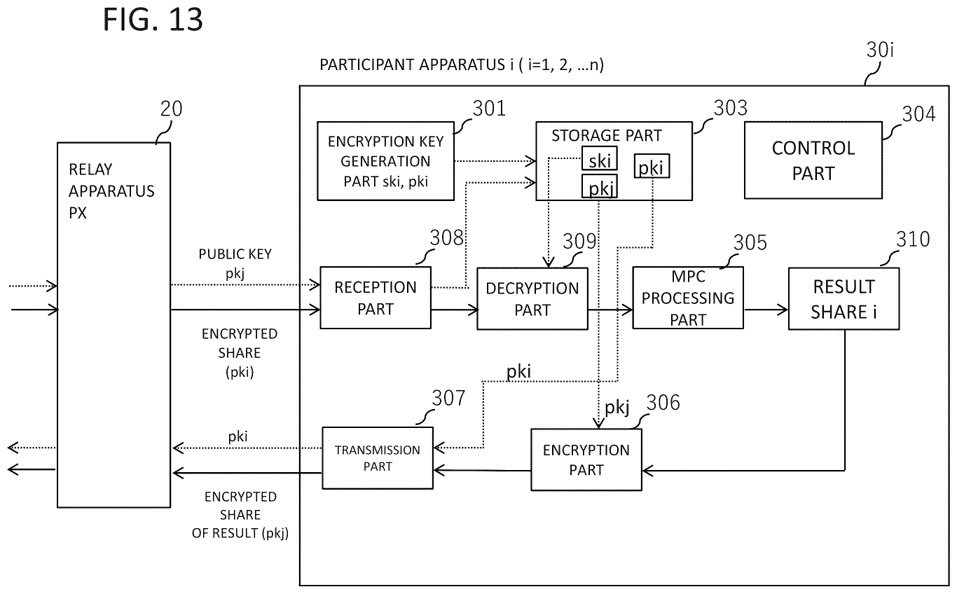

FIG. 13 schematically illustrates an example of the participant apparatus used in the present example embodiment. The participant apparatus i (30i) (i=1, 2, . . . , n; n is an integer greater than or equal to two) is constituted as the MPC operation apparatus MPCXi, includes an encryption key generation part 301, a storage part 303, a control part 304, a reception part 308, a decryption part 309, and an MPC processing part i (305), and further comprises an encryption part 306 and a transmission part 307 with respect to downlink communication. As part of a presetting process, the encryption key generation part 301 generates the secret key ski and the public key pki, for instance, and stores them in the storage part 303. The reception part 308 receives a share (pki) encrypted using the public key pki (transmitted to the relay apparatus in advance) and the public key pkj (generated by the user apparatus in advance) from the relay apparatus PX (20). The decryption part 309 decrypts the encrypted share (pki) to obtain an input share i, and the MPC processing part i (305) performs MPC processing on it to obtain a share i (310) of the computation result. The encryption part 306 encrypts the result share i using the (respective) public key pkj (generated by the user apparatus) and the transmission part 307 transmits it as the encrypted share of the result (pkj) to the relay apparatus PX. To the relay apparatus PX, the transmission part 307 also transmits in advance the public key pki generated by the encryption key generation part thereof and called from the storage part 303. During the decryption, the storage part supplies the participant apparatus's own secret key ski to the decryption part 309. The MPC operation apparatus stores each piece of supplied or generated data in the storage part 303 and calls upon it to use it as needed, but the description of these processes is omitted for the sake of simplicity. Further, the storage part 303 also stores a control program that instructs each part via the control part 304.

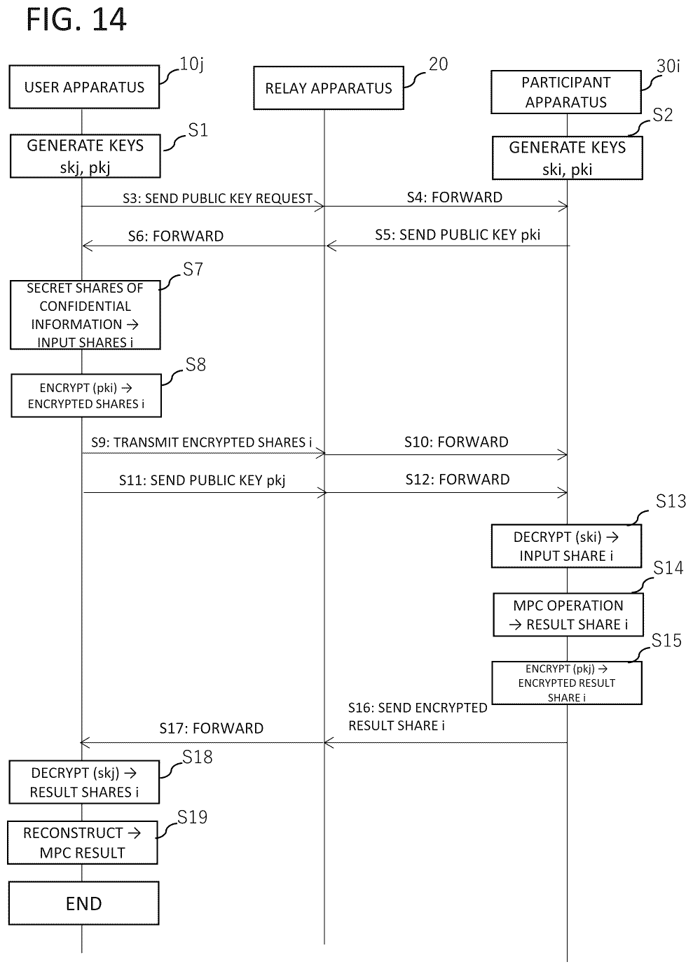

FIG. 14 illustrates the flow of a multi-party computation method relating to an example embodiment. As apparatuses involved in the flow, the user apparatus 10j, the relay apparatus PX20, and the participant apparatus 30i are listed at the top, and the flow proceeds towards the bottom of the drawing. The user apparatus 10j represents at least one user apparatus, and the participant apparatus 30i represents two or more participant apparatuses. First, the user apparatus 10j generates the secret key skj and the public key pkj (S1), and the participant apparatus 30i generates the secret key ski and the public key pki (S2). Each key is stored.

The user apparatus transmits a public key request (access or session start request) to the relay apparatus (S3), and the relay apparatus further forwards the request to the participant apparatus (S4). Upon receiving the public key request (access or session start request), the participant apparatus transmits the public key pki generated thereby to the relay apparatus (S5), and the relay apparatus then forwards the public key pki to the user apparatus (S6). At this time, the relay apparatus forwards the public key pki without revealing the source (origin) thereof. Such forwarding is possible through the settings of the control program of the relay apparatus (such as packet forwarding rules, for instance, settings of entry fields of packets).

Meanwhile, the user apparatus divides confidential information to generate secret shares of the information and obtains input shares i (S7). Then, the user apparatus encrypts (pki) the shares using the public key pki received from the relay apparatus to obtain encrypted shares i (S8).

The user apparatus transmits the encrypted shares i to the relay apparatus (S9) along with the public key pkj generated thereby (S11). The relay apparatus forwards the received encrypted shares i and public key pkj to each participant apparatus 30i (S10, S12). In a variation of this forwarding from the relay apparatus to each participant apparatus, the relay apparatus may treat a specific participant apparatus 30i as a representative (or host) participant apparatus and forward the encrypted shares and the public key pkj to all the participant apparatuses via the representative participant apparatus as needed. In this case, the representative participant apparatus shall have the relay function of the relay apparatus as a partial function, along with the functions of the participant apparatus. Further, the representative participant apparatus may forward the encrypted shares and the public key pkj to the other participant apparatuses in parallel, in a tree structure or in a combination of both. In this case, predetermined conditions for encrypted communication need to be provided.

Each participant apparatus 30i decrypts the received encrypted share i using its own secret key ski to obtain the input share i (S13) and stores it in the storage part. Then, each participant apparatus 30i performs an MPC operation using the input share i to obtain a result share i (S14). The result share i is stored in the storage part. This completes the upstream flow.

Next, the following describes the downstream flow. Each participant apparatus 30i encrypts (pkj) the result share i using the public key pkj of the user apparatus received via the relay apparatus to obtain an encrypted result share i (S15). Next, each participant apparatus 30i transmits the encrypted result share i to the relay apparatus (S16), and then the relay apparatus forwards it to the user apparatus (S17). At this time, the relay apparatus forwards the data without revealing the source (or origin) of the data. In other words, only the pure data content is forwarded.

Each user apparatus 10j decrypts (skj) the encrypted result shares i received from the relay apparatus using its own secret key skj to obtain the result shares i (S18). Then, the user apparatus aggregates and reconstructs the result shares i to obtain the result of the MPC processing on the confidential information (S19). This completes the downstream flow.

It should be noted that the time order sequence of the steps shown in the drawing is merely an example and is not limited to the sequence illustrated. For instance, the temporal order between S1 and S2 does not have to be specified, and the position of S7 is also not limited to the one shown in the drawing. Further, it is logically evident that S8 must come after S6. Additionally, the timing of each transmission from each user apparatus 10j, the relay apparatus 20, and each participant apparatus 30i can be appropriately selected.

An example embodiment shown in FIG. 14 demonstrates that MPC processing on confidential information can be performed without disclosing the locations of the MPC participants to the user under a predetermined confidential environment by allowing access from the user via the relay apparatus in a specific manner. Further, the encryption scheme used for communication is provided as an example for convenience of explanation and is not limited to the one shown in this example embodiment.

The basic flow of upstream and downstream signals through the relay apparatus can be summarized as follows:
Transmit an encryption key KA generated by an MPC operation apparatus A to a user apparatus X.
Transmit an encryption key KX generated by the user apparatus X and a share SA encrypted using the encryption key KA to the MPC operation apparatus A.
Transmit a computation result share RSX encrypted using the encryption key KX to the user apparatus X.

In other words, the relay apparatus is configured to have the functionality of transmitting an encryption key generated by a n MPC operation apparatus to the user apparatus and transmitting a share encrypted with this encryption key to the MPC operation apparatus, the source of the encryption key.

As described in the examples above, it is preferable that the relay apparatus be configured to be unable to decrypt shares, and it is desirable to employ an encryption scheme that can be utilized for this purpose. In other words, (input) shares and computation result shares are encrypted in the relay apparatus, which is configured to be unable to decrypt or reconstruct them. As a result, the original data can be effectively prevented from being reconstructed even though a plurality of shares are aggregated in the relay apparatus. That is, employing an encryption scheme in which the relay apparatus cannot reconstruct the original information from shares provides the advantage of ensuring a highly confidential environment during MPC processing. Moreover, regarding the communication between the relay apparatus and the user apparatus and the communication between the relay apparatus and the MPC participant apparatuses, it is desirable to encrypt it including the transmission and reception of encryption keys, in addition to the transmission and reception of confidential data, from the standpoint of ensuring a high level of security. One way to achieve this is to use a hybrid cryptosystem. Since the hybrid cryptosystem is well-known, a detailed process description of implementation thereof will be omitted.

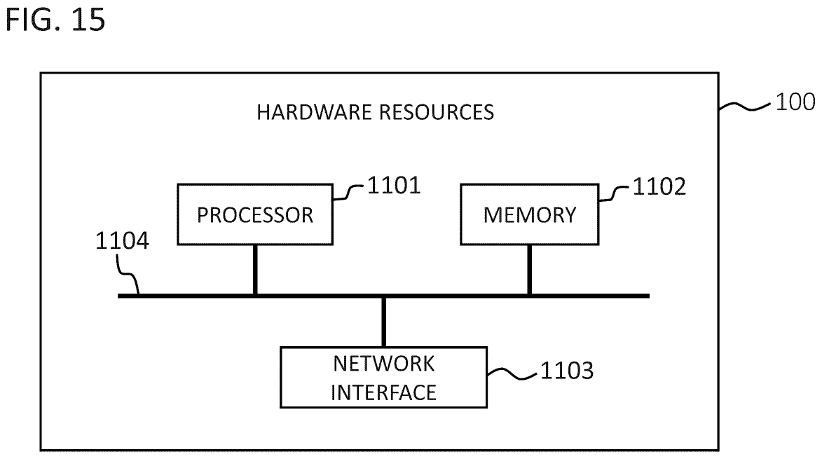

The example embodiments or the components thereof (the relay apparatus, the MPC operation apparatus, and the user apparatus) of the present disclosure can be implemented using hardware resources. FIG. 15 shows an example thereof.

For instance, hardware resources 100 (information processing apparatus, computer) constitute a processing module comprising a processor 1101, a memory 1102, and a network interface 1103, which are connected to each other by an internal bus 1104.

Note that the configuration shown in FIG. 15 is not intended to limit the hardware configuration of the hardware resources 100. The hardware resources 100 may include hardware not shown in the drawing (for instance, an input/output interface). In addition, the number of units such as the processor 1101 included in the apparatus is not limited to the example shown in the drawing; for instance, a plurality of the processors 1101 may be included in the hardware resources 100. As the processor 1101, for instance, a CPU (Central Processing Unit), an MPU (Micro Processor Unit), a GPU (Graphics Processing Unit), and the like may be used.

The memory 1102 may be one or more of, for instance, a RAM (Random Access Memory), a ROM (Read-Only Memory), an HDD (Hard Disk Drive), an SSD (Solid State Drive), and the like, preferably in combination, and a cache memory may also be provided as an auxiliary memory if necessary.

As the network interface 1103, for instance, a LAN (Local Area Network) card, a network adaptor, a network interface card, and the like may be used. The network interface 1103 can be used to implement the transmission and reception parts of the apparatuses described above. In other words, for convenience of explanation, the transmission and reception parts in each apparatus shown in the example embodiments described above are displayed as separate functional elements, but they can be implemented as an I/O interface.

The functions of the hardware resources 100 are achieved by the processing modules described above. These processing modules are realized by, for instance, having the processor 1101 execute a program stored in the memory 1102. Further, the program can be downloaded via a network or can be updated using a storage medium storing the program. In addition, the processing modules may be realized by a semiconductor chip. In other words, the functions performed by the processing modules may be realized by running software on some kind of hardware.

Some or all of the example embodiments above can be described as (but not limited to) the following Modes appended.

### Supplementary Notes

### (Mode 1)

The multi-party computation system as described in the first aspect.

### (Mode 2)

In the multi-party computation system,
the user apparatus is configured to divide information to generate secret shares of the information and encrypt the secret shares using the respective first encryption keys received from a relay system and is configured to receive shares, encrypted using the user apparatus's second encryption key, of a plurality of MPC operation results, and
the plurality of MPC operation apparatuses are configured to receive shares encrypted using the respective first encryption keys transmitted by the relay apparatus, decrypt the encrypted shares, and perform an operation using the decrypted shares.

### (Mode 3)

In the multi-party computation system,
the relay apparatus is configured to transmit the respective first encryption keys generated by the plurality of MPC operation apparatuses to the user apparatus in response to a request from the user apparatus.

### (Mode 4)

In the multi-party computation system,
the plurality of MPC operation apparatuses are configured to further decrypt shares, which are encrypted using the respective first encryption keys transmitted by the relay apparatus, using further respective third encryption keys.

### (Mode 5)

In the multi-party computation system,
the user apparatus is configured to further decrypt shares of MPC operation results, which are encrypted using the second encryption key, using a further respective fourth encryption keys.

### (Mode 6)

In the multi-party computation system,
when the relay apparatus receives encrypted shares of the results of operations performed by the plurality of MPC operation apparatuses and transmits the shares to a user apparatus without decrypting them, the user apparatus is configured to decrypt the encrypted shares of the MPC operation results.

### (Mode 7)

In the multi-party computation system,
each of the respective first encryption keys is a first public key, and the second encryption key is a second public key.

### (Mode 8)

The relay apparatus as described in the second aspect.

### (Mode 9)

The relay apparatus is configured to transmit the respective first encryption keys generated by the plurality of MPC operation apparatuses to the user apparatus in response to a request from the user apparatus.

### (Mode 10)

In the relay apparatus,
each of the respective first encryption keys is a first public key, and the second encryption key is a second public key.

### (Mode 11)

The multi-party computation method as described in the third aspect.

### (Mode 12)

The multi-party computation method includes the following steps:
having the user apparatus divide information to generate secret shares of the information, encrypt the secret shares using the respective first encryption keys received from the relay system, receive shares, encrypted using the user apparatus's second encryption key, of MPC operation results, and decrypt the encrypted shares of the MPC operation results; and
having the plurality of MPC operation apparatuses receive shares encrypted using the second encryption key transmitted by the relay system, decrypt the encrypted shares, and perform an operation using the decrypted shares.

### (Mode 13)

In the multi-party computation method,
the relay system transmits the first encryption keys generated by the plurality of MPC operation apparatuses to the user apparatus in response to a request from the client apparatus.

### (Mode 14)

In the multi-party computation method,
each of the respective first encryption keys is a first public key, and the second encryption key is a second public key.

### (Mode 15)

The multi-party computation program as described in the fourth aspect.

### (Mode 16)

The multi-party computation program includes the following processes:
having the user apparatus divide information to generate secret shares of the information, encrypt the secret shares using the respective first encryption keys received from the relay system, receive shares, encrypted using the user apparatus's second encryption key, of MPC operation results, and decrypt the encrypted shares of the MPC operation results; and
having the plurality of MPC operation apparatuses receive shares encrypted using the respective first encryption key transmitted by the relay system, decrypt the encrypted shares, and perform an operation using the decrypted shares.

### (Mode 17)

The multi-party computation program includes a process of having the relay system transmit the respective first encryption keys generated by the plurality of MPC operation apparatuses to the user apparatus in response to a request from the user apparatus.

### (Mode 18)

In the multi-party computation program,
each of the respective first encryption keys is a first public key, and the second encryption key is a second public key.

Further, the disclosure of Patent Literature and Non-Patent Literature cited above is incorporated herein in its entirety by reference thereto and can be used as a basis or a part of the present disclosure as needed. It is to be noted that it is possible to modify or adjust the example embodiments or examples within the scope of the whole disclosure of the present invention (including the Claims and the figures) and based on the basic technical concept thereof. Further, it is possible to variously combine or select (or deselect if necessary) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the figures, and the technical concept of the present invention. Particularly, any numerical values or ranges disclosed herein should be interpreted that any intermediate or lower values or subranges falling within the disclosed ranges are also disclosed even without specific recital thereof. In addition, using some or all of the disclosed elements in each literature cited above as necessary in combination with the elements described herein as part of the disclosure of the present invention in accordance with the object of the present invention shall be considered to be included in (or belong to) the disclosed elements of the present application.

### REFERENCE SIGNS LIST

10j: user apparatus j
20: relay apparatus (PX)
30i: participant apparatus i (MPC operation apparatus MPCXi)
100: hardware resources
101, 301: encryption key generation part
103, 203, 303: storage part
104, 204, 304: control part
105: secret sharing part
106, 306: encryption part
107, 307: transmission part
108, 308: reception part
109, 309: decryption part
110: reconstruction part
201A: reception part A
201B: reception part B
202A: transmission part A
202B: transmission part B
305: MPC processing part i
310: result share i
1101: processor
1102: memory
1103: network interface
1104: internal bus
ski, skj: secret key
pki, pkj: public key

What is claimed is:

1. A multi-party computation system, comprising at least one user apparatus, a plurality of MPC operation apparatuses, and a relay apparatus that relays communication between the user apparatus and the plurality of MPC operation apparatuses, wherein
the user apparatus is configured to include a secret sharing part that divides information to generate secret shares of the information, an encryption part that encrypts the secret shares, a reception part that receives-a respective first encryption keys for encrypting shares and encrypted shares of MPC operation results, and a transmission part that transmits encrypted shares and a second encryption key to the relay apparatus,
the relay apparatus is configured to include a reception part that receives encrypted shares, the respective first and the second encryption keys, and encrypted shares of MPC operation results and a transmission part that transmits encrypted shares, the respective first and the second encryption keys, and encrypted shares of MPC operation results,
the plurality of MPC operation apparatuses are configured to include a reception part that receives encrypted shares and the second encryption key, a key generation part that generates a key, a decryption part that decrypts encrypted shares, and an operation part that performs an operation using decrypted shares,
the relay apparatus is further configured to receive the respective first encryption keys generated by the plurality of MPC operation apparatuses and further transmit the respective first encryption keys to the user apparatus and is configured to receive secret shares generated by the user apparatus and encrypted thereby using the respective first encryption keys and the second encryption key generated by the user apparatus and transmit the encrypted secret shares and the second encryption key to the plurality of MPC operation apparatuses, and
the relay apparatus is further configured to receive shares, encrypted using the user apparatus's second encryption key, of the results of operations performed by the plurality of MPC operation apparatuses and transmit the shares to the user apparatus.

2. The party computation system according to claim 1, wherein
the user apparatus is configured to divide information to generate secret shares of the information and encrypt the secret shares using the respective first encryption keys received from a relay system and is configured to receive shares, encrypted using the user apparatus's second encryption key, of MPC operation results, and
the plurality of MPC operation apparatuses are configured to receive shares encrypted using the respective first encryption keys transmitted by the relay apparatus, decrypt the encrypted shares, and perform an operation using the decrypted shares.

3. The multi-party computation system according to claim 1, wherein
the relay apparatus is configured to transmit the respective first encryption keys generated by the plurality of MPC operation apparatuses to the user apparatus in response to a request from the user apparatus.

4. The multi-party computation system according to any one of claim 1, wherein
the plurality of MPC operation apparatuses are configured to further decrypt shares, which are encrypted using the respective first encryption keys transmitted by the relay apparatus, using further respective third encryption keys.

5. The multi-party computation system according to claim 1, wherein
the user apparatus is configured to further decrypt shares of MPC operation results, which are encrypted using the second encryption key, using further respective fourth encryption keys.

6. The multi-party computation system according to claim 1, wherein
when the relay apparatus receives encrypted shares of the results of operations performed by the plurality of MPC operation apparatuses and transmits the shares to a user apparatus without decrypting them, the user apparatus is configured to decrypt the encrypted shares of the MPC operation results.

7. The multi-party computation system according to claim 1, wherein
each of the respective first encryption keys is a first public key in public key cryptography, and the second encryption key is a second public key in public key cryptography.

8. A relay apparatus, that relays communication between a user apparatus and a plurality of MPC operation apparatuses in a multi-party computation system including at least one user apparatus and a plurality of MPC operation apparatuses, wherein
the relay apparatus comprises a reception part that receives encrypted shares and respective first and the second encryption keys and a transmission part that transmits encrypted shares and the respective first and the second encryption keys for encryption, one of each for the user apparatus and the MPC operation apparatuses,
the relay apparatus is configured to receive the respective first encryption keys generated by the plurality of MPC operation apparatuses and further transmit the respective first encryption keys to the user apparatus and is configured to receive secret shares generated by the user apparatus and encrypted thereby using the respective first encryption keys and a second encryption key generated by the user apparatus and transmit the encrypted secret shares and the second encryption key to the plurality of MPC operation apparatuses, and
the relay apparatus is further configured to receive shares, encrypted using the user apparatus's second encryption key, of the results of operations performed by the plurality of MPC operation apparatuses and transmit the shares to the user apparatus.

9. The relay apparatus according to claim 8, wherein
the relay apparatus is configured to transmit the respective first encryption keys generated by the plurality of MPC operation apparatuses to the user apparatus in response to a request from the user apparatus.

10. The relay apparatus according to claim 8, wherein
each of the respective first encryption keys is a first public key in public key cryptography, and the second encryption key is a second public key in public key cryptography.

11. A multi-party computation method, comprising the following:
using a relay system that relays communication between a user apparatus and a plurality of MPC operation apparatuses in a multi-party computation system including at least one user apparatus and a plurality of MPC operation apparatuses;
having the relay system receive respective first encryption keys generated by the plurality of MPC operation apparatuses and further transmit the respective first encryption keys to the user apparatus;
having the relay system receive secret shares generated by the user apparatus and encrypted thereby using the respective first encryption keys and a second encryption key generated by the user apparatus and transmit the encrypted secret shares and the second encryption key to the plurality of MPC operation apparatuses; and
having the relay system further receive shares, encrypted using the user apparatus's second encryption key, of the results of operations performed by the plurality of MPC operation apparatuses and transmit the shares to the user apparatus.

12. The multi-party computation method according to claim 11 comprising the following:
having the user apparatus divide information to generate secret shares of the information, encrypt the secret shares using the respective first encryption keys received from the relay system, receive shares, encrypted using the user apparatus's second encryption key, of MPC operation results, and decrypt the encrypted shares of the MPC operation results; and
having the plurality of MPC operation apparatuses receive shares encrypted using the second encryption key transmitted by the relay system, decrypt the encrypted shares, and perform an operation using the decrypted shares.

13. The multi-party computation method according to claim 11, wherein
the relay system transmits the first encryption keys generated by the plurality of MPC operation apparatuses to the user apparatus in response to a request from the user apparatus.

14. The multi-party computation method according to claim 11 wherein
each of the respective first encryption keys is a first public key in public key cryptography, and the second encryption key is a second public key in public key cryptography.

15. A non-transitory computer readable medium storing a multi-party computation program causing a computer to execute the following processes:
using a relay system that relays communication between a user apparatus and a plurality of MPC operation apparatuses in a multi-party computation system including at least one user apparatus and a plurality of MPC operation apparatuses;
having the relay system receive respective first encryption keys generated by the plurality of MPC operation apparatuses and further transmit the respective first encryption keys to the user apparatus;
having the relay system receive secret shares generated by the user apparatus and encrypted thereby using the respective first encryption keys and a second encryption key generated by the user apparatus and transmit the encrypted secret shares and the second encryption key to the plurality of MPC operation apparatuses; and
having the relay system further receive shares, encrypted using the user apparatus's second encryption key, of the results of operations performed by the plurality of MPC operation apparatuses and transmit the shares to the user apparatus.

16. The non-transitory computer readable medium storing the multi-party computation program according to claim 15 comprising the following processes:
having the user apparatus divide information to generate secret shares of the information, encrypt the secret shares using the respective first encryption keys received from the relay system, receive shares, encrypted using the user apparatus's second encryption key, of MPC operation results, and decrypt the encrypted shares of the MPC operation results; and
having the plurality of MPC operation apparatuses receive shares encrypted using the respective first encryption key transmitted by the relay system, decrypt the encrypted shares, and perform an operation using the decrypted shares.

17. The non-transitory computer readable medium storing the multi-party computation program according to claim 15 comprising a process of having the relay system transmit the respective first encryption keys generated by the plurality of MPC operation apparatuses to the user apparatus in response to a request from the user apparatus.

18. The non-transitory computer readable medium storing the multi-party computation program according to claim 15, wherein
each of the respective first encryption keys is a first public key in public key cryptography, and the second encryption key is a second public key in public key cryptography.
